(19) United States
(12) Patent Application Publication
(10) Pub. No.: US 2007/0074767 A1
(43) Pub. Date: Apr. 5, 2007

(54) Self-charging programmable water valve

(76) Inventor: Tony W. Roffey, Wixom, WI (US)

Correspondence Address: LITMAN LAW OFFICES, LTD, PO BOX 15035, CRYSTAL CITY STATION, ARLINGTON, VA, 22215, US

(21) Appl. No.: 11/528,401

(22) Filed: Sep. 28, 2006

Related U.S. Application Data
(60) Provisional application No. 60/721,994, filed on Sep. 30, 2005.

(51) Int. Cl. F16K 31/12

(52) U.S. Cl. 137/487.5

(57) ABSTRACT

The self-charging programmable water valve provides programmed watering control to a portion of an irrigation zone. A rechargeable battery provides electrical power to control the valve, which includes a pulse charger activated by water flow through the valve for recharging the battery. A pressure sensor is connected to a control circuit that activates the water valve when water pressure detected by the sensor exceeds a predetermined limit. A first digital timer determines valve open duration, and thus how long the portion of the zone will receive water. A second digital timer begins a count cycle after the first digital timer shuts down the water flow to the connected branch. The second digital timer is provided to prevent false reactivation of the water valve during a zone watering cycle, thereby preventing excessive watering of the portion of the zone controlled by the programmable water valve.

### CROSS-REFERENCE TO RELATED APPLICATION

This application claims the benefit of U.S. Provisional Patent Application Ser. No. 60/721,994, filed Sep. 30, 2005.

### BACKGROUND OF THE INVENTION

1. Field of the Invention

The present invention relates to irrigation systems, and more specifically, to a self-charging, programmable water valve.

2. Description of the Related Art

Water valve systems have been programmable for decades. Over the years, various mechanical and electromechanical systems have been developed for the purpose of reducing labor associated with irrigating lawns, gardens, crops, and the like.

The common theme in these systems has been the design of a water delivery layout to cover all areas in need of irrigation, the underground installation of pipes that lead to in-ground or above-ground controllable sprinklers, and the installation and connection of a control system to provide timing of system operation. The control system is usually a timer connected to a valve control in the water supply. Timers may be mechanical, electromechanical, analog or digital. Most modern applications rely on programmable digital timers to control the water supply. The timers and control are usually set up to accommodate different zones in the water delivery layout. The result is a multi-zone control system in which the different zones may be independently controlled for irrigation duration.

In a typical system layout, the number of zones is usually restricted to keep installation and operational costs within budgetary constraints. Because of this restriction, a particular zone may span a region of ground that has variations in topology, soil characteristics, and the like. Thus, a problem that often occurs is that a particular zone programmed for a specific duration of irrigation may deliver just the right of amount of water to a section of the zone, but deliver too much water to a different section of the zone, resulting in flooding or oversaturation of water one or more zone sections.

A solution that has heretofore been applied is the breakup of the zone into two separate zones that can be individually programmed. That solution is less than optimal because it introduces added complexity and cost to the system due to retrenching of new pipe, etc. It would be desirable to have a solution that did not rely on creating an entirely new zone to deal with flooding of a subsection of the problem zone.

Thus, a self-charging, programmable water valve solving the aforementioned problems is desired.

### SUMMARY OF THE INVENTION

The self-charging, programmable water valve provides programmed zone control that utilizes the water flow through the valve to provide an electric current for recharging an associated battery power supply. The battery provides electrical power to control the valve and associated electronic components. Circuitry activates the water valve in response to water pressure detected by a pressure sensor. A first digital timer determines valve open duration, and thus how long a connected zone branch will receive water. While the valve is operating, a pulse battery charger provides charging current for the battery, so long as water flows through the water valve.

A second digital timer begins a count cycle after the first digital timer shuts down the water flow to the connected branch. The second digital timer is provided to prevent false re-activation of the water valve during a zone watering cycle. The aforementioned features provide the capability to irrigate a zone branch or subsection susceptible to oversaturation without causing flooding because the water valve only opens in response to system pressure, and closes in response to a predetermined timer value chosen by the user to prevent re-activation of the valve and avoid water saturation in the problem zone branch.

These and other features of the present invention will become readily apparent upon further review of the following specification and drawings.

### BRIEF DESCRIPTION OF THE DRAWINGS

FIG. 1 is an environmental, perspective view of a self-charging, programmable water valve according to the present invention.

FIG. 2 is a perspective view of the self-charging, programmable water valve of the present invention.

FIG. 3 is a diagrammatic view showing a typical application for the self-charging, programmable water valve of the present invention.

FIG. 4 is a block diagram of the self-charging, programmable water valve of the present invention.

FIG. 5 is a flow diagram of programmed logic provided for implementation of the self-charging, programmable water valve of the present invention.

Similar reference characters denote corresponding features consistently throughout the attached drawings.

### DETAILED DESCRIPTION OF THE PREFERRED EMBODIMENT

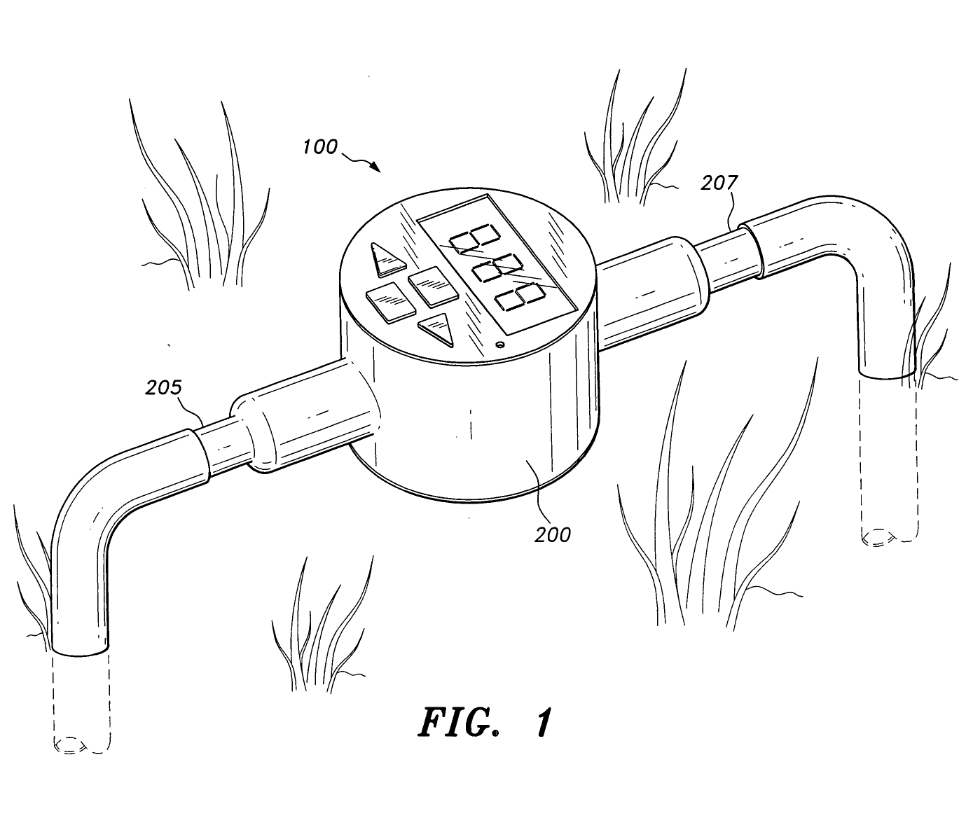

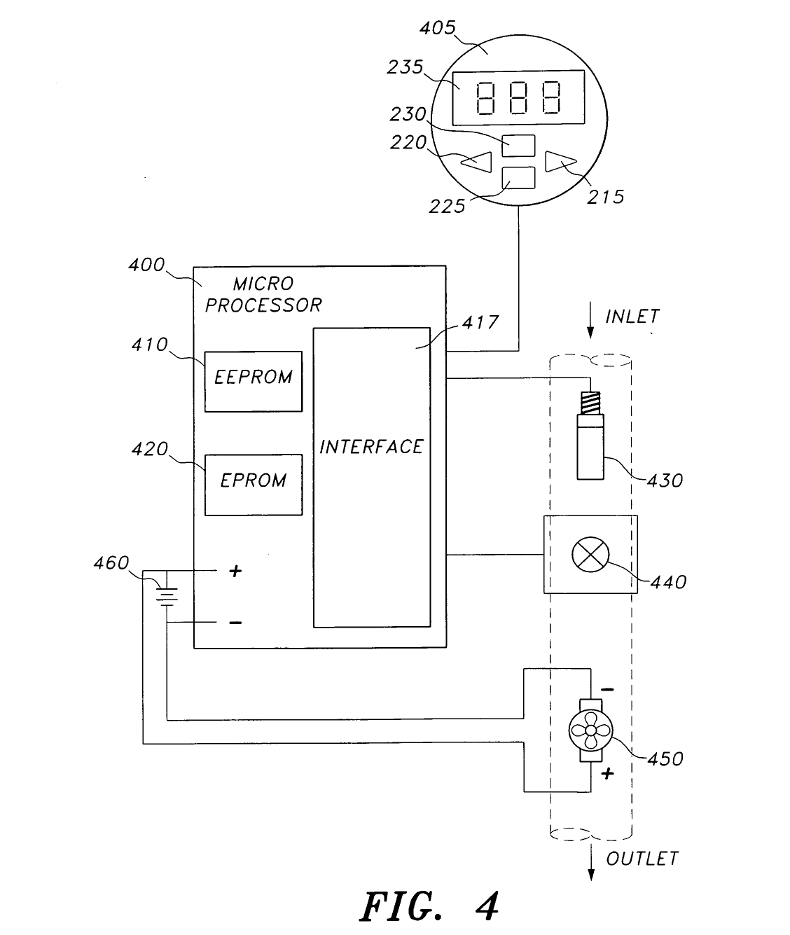

Referring to FIGS. 1-5, the present invention is a self-charging, programmable water valve 100 that includes a rechargeable battery 460 (shown schematically in FIG. 4) to provide electrical power to the programmable water valve 100 and associated electronic components. The water valve 100 is opened in response to water pressure detected by a pressure sensor 430. A first digital timer determines valve open duration, and thus how long a connected zone branch will receive water.

While the valve 100 is operational and open to water flow, a pulse battery charger comprising a mini-turbine generator 450 at the outlet end of the water valve 100 charges the system battery 460.

A second digital timer is provided to determine a duration in which the system remains inactive, i.e., after the first digital timer shuts down the water flow to the connected branch, the valve 100 cannot be opened again until the second digital timer times out. The second digital timer is provided to prevent false activation of the water valve during a zone watering cycle.

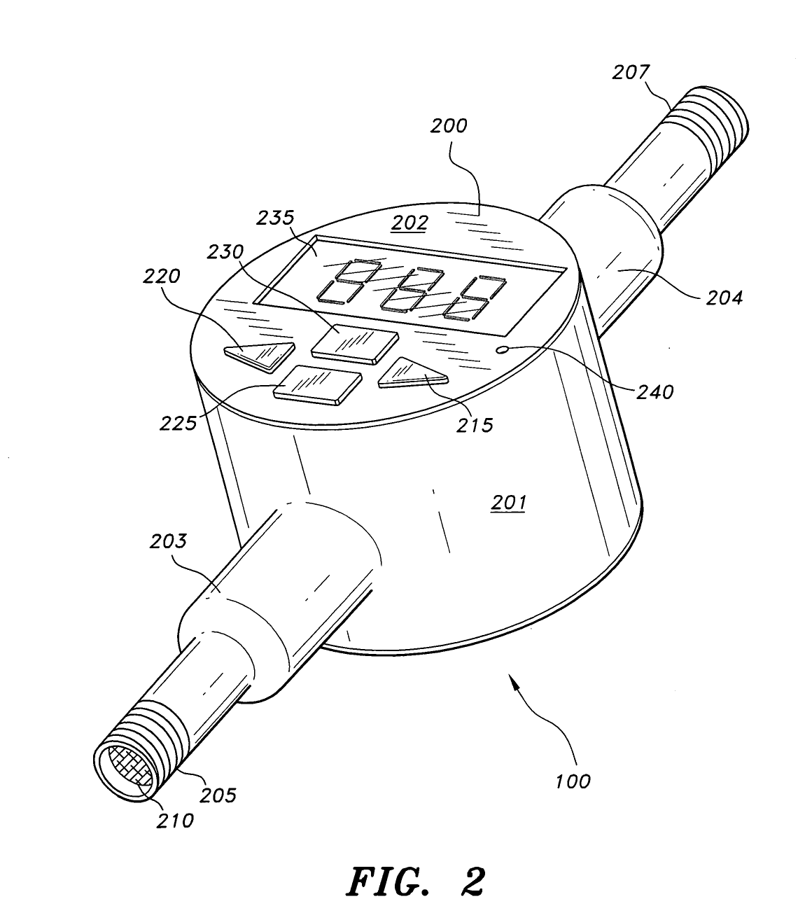

As shown in FIGS. 1 and 2, the self-charging, programmable water valve 100 is a self-contained unit in a truncated cylindrical housing 200 having: an inlet pipe 203 extending from the sidewall 201 of the housing 200, the inlet pipe 203 having a threaded inlet connection 205; an outlet pipe 204 extending from the sidewall 201 180° opposite the inlet pipe 203, the outlet pipe 204 having a threaded outlet connection 207; and a top face 202 having a user interface comprising a digital display 235 with function buttons 215, 220, 225, 230 and bypass switch 240. Preferably, the unit 100 is encased in a heavy duty, impact resistant and water tight plastic housing 200.

Inlet pipe 203 and outlet pipe 204 may have ½″ to 2″ diameter orifices in order to provide compatibility with most existing irrigation systems. In addition, inlet pipe 205 is fitted with a debris screen 210 to keep pebbles and other obstructions or debris from entering the valve 100 as water flows through the device.

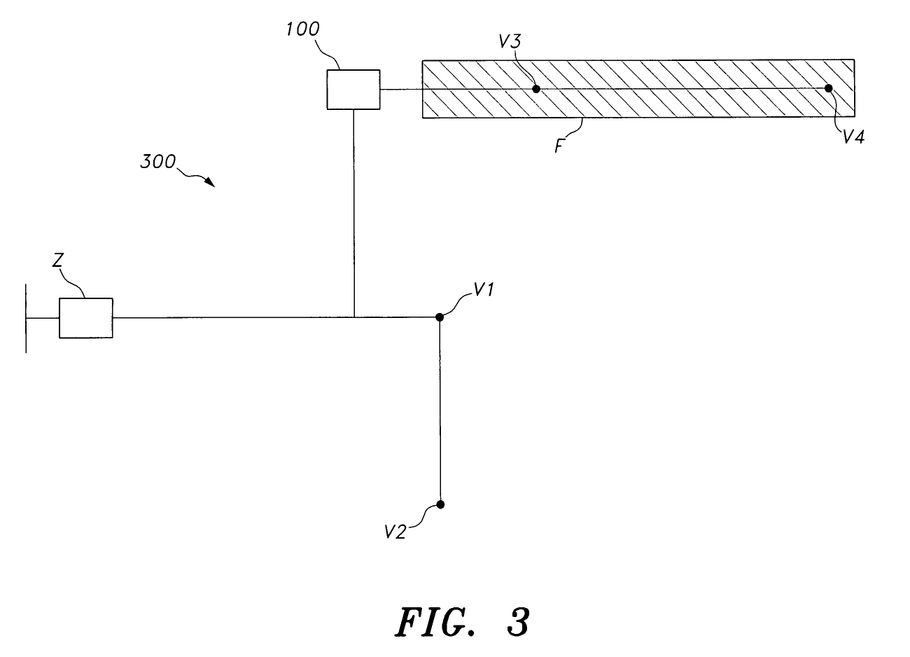

Referring to FIG. 3, the valve 100 breaks up zone Z so that sprinkler heads V3 and V4, which supply water to flood area F, are open for a lesser duration than the portion of the zone Z irrigated by sprinkler heads V1 and V2. Advantageously, the present invention avoids the necessity of creating a new zone for flood area F.

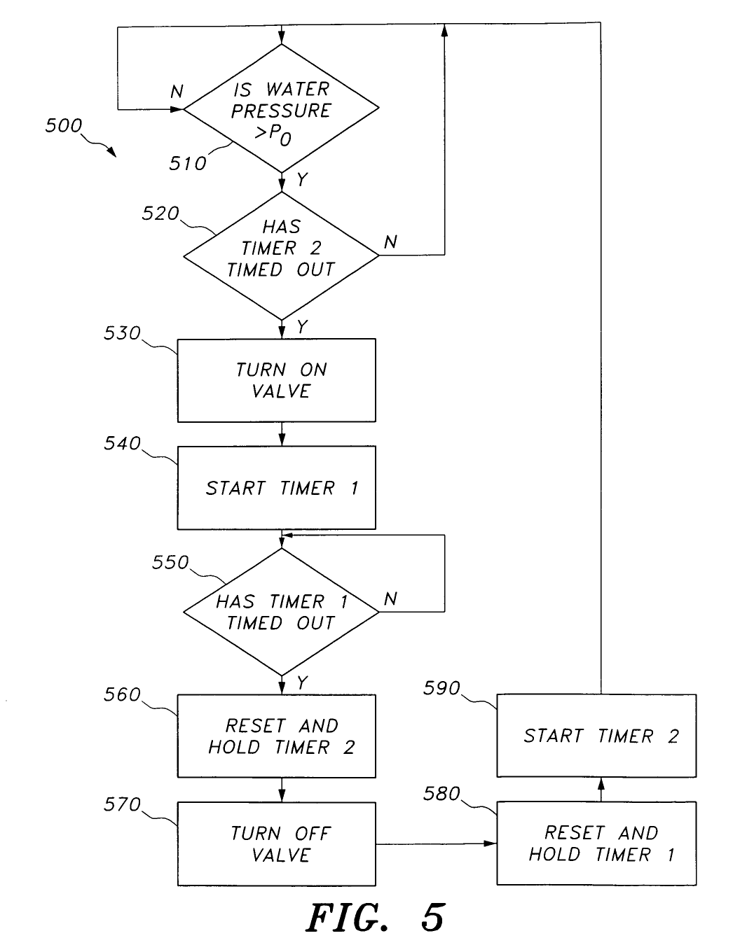

Referring to FIGS. 4 and 5, water valve 100 is comprised of an electrically controlled water valve 440, with a control input being connected to microprocessor 400 at an interface 41 7 of the microprocessor 400. Similarly, the pressure sensor 430 is connected to microprocessor 400. A user interface 405 is also connected to microprocessor 400. The microprocessor 400 has the capability to provide a control signal to open or shut electrically controlled water valve 440. Moreover, microprocessor 400 may accept analog and/or digital output values from the pressure sensor 430.

Microprocessor 400 transmits and receives digital signals from the user interface 405 in order to provide a user-friendly programmable operational interface to the user. For example, left arrow button 220 may be provided as a timer decrement button, which can serially decrease a number shown in digital display 235 until a desired number is displayed.

Similarly right arrow button 214 may be provided as a timer increment button, which can serially increase a number shown in digital display 235 until a desired number is displayed. Pad button 230 may be provided to perform a commit function, which commits the number displayed in digital display 235 to programmable read only memory (PROM), such as EEPROM 410 of microprocessor 400.

Pad button 225 may be provided to perform a menu advance function, in which a particular range of menu options may be selected by the user so that the user can set sprinkler duration and inactivity duration using the arrow 215, 220 and commit 230 buttons and pad. If desired, a switch 240 (shown in FIG. 2) may be provided for bypassing the timers, or a bypass function may be programmed into read only memory and accessed through the menu 225 and commit 230 buttons.

The user interface discussed above is exemplary only and does not restrict the scope of the present invention to the aforementioned button and display configurations.

As shown in FIGS. 4-5, the programmable features of the self-charging, programmable water valve 100 are implemented in programmed logic in the form of computer readable instructions stored in a programmable read only memory, such as EPROM 420 of the microprocessor 400. For example, a predetermined water pressure value is stored in microprocessor 400 programmable memory.

The functionality of the pressure switch is achieved by comparing the water pressure value detected by sensor 430 to the predetermined water pressure value in EPROM memory 420, as indicated at step 510 of the flowchart of FIG. 5. After initialization 560, 580, 590 of digital timers executed under program control of microprocessor 400, the water pressure value is compared to the stored value.

Once the stored value has been exceeded, program control of microprocessor 400 proceeds to decision branch 520 to determine if an inactivity timer has timed out, e.g., by being incremented to a predetermined value stored in programmable memory of microprocessor 400. According to decision branches 510 and 520, no commands from microprocessor 400 will be issued to electrically controlled water valve 440 until the water pressure exceeds the threshold at step 510 and the inactivity timer has timed out at step 520.

After the aforementioned conditions at steps 510 and 520 have been met, microprocessor 400 executes programmed instructions commanding the electrically controlled water valve 440 to open at step 530. Microprocessor programmed instructions start an irrigation duration timer at step 540. Decision branch 550 determines when the irrigation duration timer has timed out, i.e., incremented to a predetermined value stored in programmable memory of microprocessor 400.

Once it has been determined under programmed instructions 550 that the irrigation duration timer has timed out, programmed instructions at 560 reset the inactivity timer. Subsequently programmed instructions at 570 cause microprocessor 400 to command electrically controlled water valve 440 to close, to reset and hold the first timer at step 580, and to start the second timer at step 590, the first and second timers preferably being software timers maintained by the microprocessor 400.

It will be understood that electrically controlled valve 440 may be any type of water valve known in the art, e.g., a solenoid valve operated by a relay or other switch connected to the microprocessor 400. It will also be understood that the term “microprocessor” includes a microprocessor, microcontroller, or other programmable or programmed device capable of executing the instructions outlined in the flowchart of FIG. 5.

It is to be understood that the present invention is not limited to the embodiment described above, but encompasses any and all embodiments within the scope of the following claims.

I claim:

1. A self-charging programmable water valve, comprising:
an electrically controlled water valve having a housing and inlet and outlet pipes extending from the housing;
a water pressure sensor disposed in the inlet pipe of the valve;
means for opening the water valve in response to an increase in pressure detected by the pressure sensor;
a microprocessor-controlled circuit disposed in the housing providing a first programmable timer circuit and a second programmable timer circuit;
means for closing the valve in response to a signal from the first programmable timer circuit;
a rechargeable battery electrically connected to the microprocessor-controlled circuit;
a pulse battery charger disposed in the housing and electrically connected to the battery for recharging the battery in response to water flow through the valve;
means for keeping the water valve closed for a predetermined time interval during a zone watering cycle as determined by the second programmable timer; and
a user interface disposed in the housing and electrically connected to the microprocessor-controlled circuit for programming the timer circuits.

2. The self-charging programmable water valve according to claim 1, wherein the inlet pipe has a threaded inlet connection.

3. The self-charging programmable water valve according to claim 1, wherein the outlet pipe has a threaded outlet connection.

4. The self-charging programmable water valve according to claim 1, wherein the user interface comprises a digital display, function buttons, and a bypass switch electrically connected to said microprocessor-controlled circuit.

5. The self-charging programmable water valve according to claim 1, wherein the housing is formed from a heavy duty, impact resistant, watertight material.

6. The self-charging programmable water valve according to claim 1, wherein the inlet and outlet pipe orifices are between ½″ to 2″ in diameter.

7. The self-charging programmable water valve according to claim 1, further comprising a debris screen disposed in the inlet pipe to prevent obstructions from entering the valve as water flows through the water valve.

8. The self-charging programmable water valve according to claim 1, wherein said means for opening the water valve in response to an increase in pressure detected by the pressure sensor comprises:
means for storing a pressure limit in said microprocessor controlled circuit;
means for comparing pressures measured by said pressure sensor to the pressure limit, said microprocessor-controlled circuit generating a control signal when the measured pressures exceed the pressure limit and said second programmable timer circuit has timed out; and
means responsive to the control signal for opening said water valve.

9. The self-charging programmable water valve according to claim 1, wherein the user interface comprises a digital display, function buttons, and a bypass switch electrically connected to said microprocessor-controlled circuit, the function buttons of the user interface further comprising timer increment and decrement functions to program the first and second programmable timer circuits.

10. The self-charging programmable water valve according to claim 9, wherein the function buttons of said user interface further comprise:
a pad button; and
a storage circuit connected to the pad button for committing a number shown on said digital display to storage in a memory circuit of the microprocessor.

11. The self-charging programmable water valve according to claim 1, wherein said microprocessor-controlled circuit comprises circuits for programmably setting sprinkler on and off duration.

12. The self-charging programmable water valve according to claim 1, wherein said user interface further comprises a bypass switch electrically connected to said microprocessor-controlled circuit for bypassing control of the water valve by said first and second timer circuits.

13. A programmable water valve, comprising:
an electrically controlled water valve having a housing and inlet and outlet pipes extending from the housing;
a water pressure sensor disposed in the inlet pipe of the valve;
means for opening the water valve in response to an increase in pressure detected by the pressure sensor;
a microprocessor-controlled circuit disposed in the housing providing a first programmable timer circuit and a second programmable timer circuit;
an electric power source electrically connected to the microprocessor-controlled circuit;
means for closing the valve after expiration of a sprinkler “on” time selectively programmed into the first programmable timer circuit;
means for keeping the water valve closed for a predetermined time interval selectively programmed into the second programmable timer; and
a user interface disposed in the housing and electrically connected to the microprocessor-controlled circuit for selectively programming the timer circuits.
